(19) United States
(12) Patent Application Publication
(10) Pub. No.: US 2004/0058248 A1
(43) Pub. Date: Mar. 25, 2004

(54) Negative electrode material and battery using the same

(76) Inventor: Hiroshi Inoue, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/463,372

(22) Filed: Jun. 16, 2003

(30) Foreign Application Priority Data
Jun. 20, 2002 (JP) JP2002-180422

(51) Int. Cl. H01M 4/80; H01M 4/58

(52) U.S. Cl. 429/235; 429/231.4; 429/231.95

(57) ABSTRACT

A battery that can achieve both of a large capacity and excellent charge/discharge cycle characteristics is provided. A negative electrode in a disk shape housed in an outer cup is stacked on a positive electrode in a disk shape housed in an outer can through a separator. The negative electrode is formed to include a porous body composed of a pure substance, an alloy, or a compound of a metallic element or a semimetallic element that can be alloyed with lithium, and having holes in a continuous solid body. Since the porous body is unlikely to break down in absorbing and desorbing lithium, excellent charge/discharge cycle characteristics can be provided.

### RELATED APPLICATION DATA

This application claims priority to Japanese Patent Application JP 2002-180422 filed on Jun. 20, 2002, and the disclosure of that application is incorporated herein by reference to the extent permitted by law.

### BACKGROUND OF THE INVENTION 1. Field of the Invention

The present invention relates to a negative electrode material including a pure substance, an alloy, or a compound of a metallic element or a semimetallic element that can be alloyed with lithium, and to a battery using the same. 2. Description of the Related Art

The advancement of electronic technology in recent years has led to the development of small portable electronic appliances such as a camera-integrated video tape recorder, a cellular phone, and a laptop computer. For a portable power source of the electronic appliances, it is strongly demanded to develop a secondary battery which has a small size, a light weight, and a high energy density.

Secondary batteries satisfying that demand currently under use include a lithium ion secondary battery which employs, as a negative electrode material, a graphite material that uses an intercalation reaction of lithium ion into graphite layers, or a carbonaceous material in which an absorption and desorption reaction of lithium ion into and from pores are utilized.

In the graphite material that uses the intercalation reaction, however, the capacity of the resulting negative electrode has an upper limit as defined by the composition C₆Li of the first stage graphite intercalation compound. On the other hand, in the carbonaceous material, control of the minute pore structure is industrially difficult, and an increase in the number of the pores causes a reduction in specific gravity to make it impossible to improve the negative electrode capacity per unit volume. For these reasons, it is thought that currently available carbonaceous materials have difficulty in supporting future trends of a longer operation time of the electronic appliances and a higher energy density of the power source. Thus, a negative electrode material with a more excellent ability to absorb and desorb lithium needs to be developed, and studies have been conducted actively to develop a non-carbonaceous material for the negative electrode using a metal which can be alloyed with lithium.

### SUMMARY OF THE INVENTION

Such a non-carbonaceous material for the negative electrode using a metal which can be alloyed with lithium, however, involves a problem such that it cannot be used for the secondary battery because it changes in volume and even breaks down in absorption and desorption of lithium, thereby suffering significant degradation when it is repeatedly used for the battery.

The present invention has been made in view of the aforementioned problem, and there is a need to provide a negative electrode material which has a favorable ability to absorb and desorb lithium and allows repeated use.

In addition, there is a need to provide a battery which may provide a large capacity and excellent charge/discharge cycle characteristics.

A negative electrode material according to an aspect of the present invention includes a porous body composed of a pure substance, an alloy, or a compound of a metallic element or a semimetallic element which can be alloyed with lithium. The porous body has holes in a continuous solid body.

A battery according to an aspect of the present invention includes a positive electrode, a negative electrode, and an electrolyte. The negative electrode includes a porous body composed of a pure substance, an alloy, or a compound of a metallic element or a semimetallic element which can be alloyed with lithium. The porous body has holes in a continuous solid body.

Since the negative electrode material according to the present invention employs the pure substance, the alloy, or the compound of the metallic element or the semimetallic element, which can be alloyed with lithium, a large capacity may be provided. In addition, the porous body allows changes in volume in absorbing and desorbing lithium to be accommodated, so that a breakdown is unlikely to occur.

In addition, since the battery according to the present invention employs the negative electrode material according to the present invention, a large capacity and excellent charge/discharge cycle characteristics can be achieved.

According to an embodiment of the present invention, a large capacity may be achieved by the excellent ability to absorb and desorb lithium provided by the pure substance, the alloy, or the compound of the metallic element or the semimetallic element, which can be alloyed with lithium. In addition, since the porous body enable changes in volume so as to be accommodated in absorbing and desorbing lithium, it is possible to prevent a breakdown when the secondary battery is repeatedly used.

In the negative electrode material according to another embodiment of the present invention, the porous body has a hole rate ranging from 5% or higher to 70% or lower, or from 20% or higher to 50% or lower. Thus, changes in volume in absorbing and desorbing lithium may be more accommodated to more satisfactorily prevention of breaking down when it is repeatedly used.

In the battery according to still another embodiment of the present invention, the porous body has a hole rate ranging from 5% or higher to 70% or lower, or from 20% or higher to 50% or lower, or the negative electrode further includes a carbonaceous material capable of absorbing and desorbing lithium. Accordingly, more excellent charge/discharge cycle characteristics may be provided.

### BRIEF DESCRIPTION OF THE DRAWINGS

The features and advantages of the present invention will become more apparent in the following description of the presently preferred exemplary embodiments of the invention taken in conjunction with the accompanying drawings, in which:

FIG. 1 is a sectional view showing the configuration of a secondary battery according to a first embodiment of the present invention;

FIG. 2 is a sectional view showing the configuration of a secondary battery according to a second embodiment of the present invention; and

FIG. 3 is a graph showing the relationship between a discharge capacity retention rate and a hole rate of porous bodies according to Examples 1 to 6 of the present invention.

### DESCRIPTION OF THE PREFERRED EMBODIMENTS

Preferred embodiments of the present invention will be hereinafter described in detail with reference to the drawings.

First Embodiment

A negative electrode material according to a first embodiment of the present invention includes a porous body composed of a pure substance, an alloy, or a compound of a metallic element or a semimetallic element that can be alloyed with lithium. The porous body has holes in a continuous solid body. The porous body does not refer an aggregate having holes formed therein by aggregating powder with no holes. The porous body may be in any form, for example, in a powdery form or a flat plate form. The holes may be through holes or closed pores. Specific examples of the porous body include a so-called foam metal. The first embodiment employs such a porous body so as to absorb changes in volume during absorption and desorption of lithium, thereby making it possible to reduce the possibility of causing a breakdown.

It should be noted that examples of the alloy include an alloy composed of one or more metallic elements and one or more semimetallic elements, in addition to an alloy composed of two or more metallic elements. The alloy may have composition such as solid solution, eutectic (an eutectic mixture), intermetallic compound, or at least two of them present at the same time.

The hole rate in the porous body (the rate of the holes in the porous body) is preferably 5% or higher and 70% or lower, and more preferably 20% or higher and 50% or lower. Such a rate is preferable because the changes in volume during absorption and desorption of lithium can be more favorably accommodated thereby the breakdown can be more satisfactorily prevented when the battery is repeatedly used. When the porous body is in the powdery form, the hole rate refers to a hole rate in each particle, not a hole rate of the aggregate having the holes therein by aggregating powder. The hole rate can be determined by a known method, for example by measurements with a mercury porosimeter or calculations from the density.

Examples of the metallic element or the semimetallic element which can be alloyed with lithium include, for example, magnesium (Mg), boron (B), arsenic (As), aluminum (Al), gallium (Ga), indium (In), silicon (Si), germanium (Ge), tin (Sn), lead (Pb), antimony (Sb), bismuth (Bi), cadmium (Cd), silver (Ag), zinc (Zn), hafnium (Hf), zirconium (Zr), yttrium (Y), palladium (Pd), and platinum (Pt).

Example of the alloy or the compound of those elements include, for example, ones expressed by the chemical formula MaₛMbₜLiᵤ or the chemical formula MaₚMc_{q}Mdᵣ. In these chemical formulas, Ma represents at least one of the metallic elements and semimetallic elements which can form an alloy or a compound with lithium, Mb represents at least one of the metallic elements and semimetallic elements other than lithium and Ma, Mc represents at least one of non-metallic elements, and Md represents at least one of the metallic elements and semimetallic elements other than Ma. The values of s, t, u, p, q, and r are defined by s>0, t≧0, u≧0, p>0, q>0, and r≧0, respectively.

Among them, the element of tin, lead, silicon, germanium, aluminum or indium, or an alloy or a compound thereof is preferably used. More preferably, a metallic element or a semimetallic element in Group 4B in the short periodic table is used. Most preferably, silicon, tin, or an alloy or a compound of thereof is used since a larger capacity can be provided. It should be noted that they may be crystalline or amorphous.

Specific examples of such alloys or compounds include LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, AsSn, AuSn, CaSn₃, CeSn₃, CoCu₂Sn, Co₂MnSn, CoNiSn, CoSn₂, Co₃Sn₂, CrCu₂Sn, Cu₂FeSn, CuMgSn, Cu₂MnSn, Cu₄MnSn, Cu₂NiSn, CuSn, Cu₃Sn, Cu₆Sn₅, FeSn₂, IrSn, IrSn₂, LaSn₃, MgNi₂Sn, Mg₂Sn, MnNi₂Sn, MnSn₂, Mn₂Sn, Mo₃Sn, Nb₃Sn, NdSn₃, NiSn, Ni₃Sn, PdSn, Pd₃Sn, Pd₃Sn₂, PrSn₃, PtSn, PtSn₂, Pt₃Sn, PuSn₃, RhSn, Rh₃Sn₂, RuSn₂, SbSn, SnTi₂, Sn₃U, SnV₃, SiOᵥ (O<v≦2), SnO_{w} (0<w≦2), SnSiO₃, LiSiO, or LiSnO.

The negative electrode material having such composition can be fabricated by various methods, for example, by plating urethane foam with a metal and then removing the urethane foam, or by blowing a gas into a metal solution before casting.

The negative electrode material thus fabricated is used for a negative electrode of a secondary battery as described below.

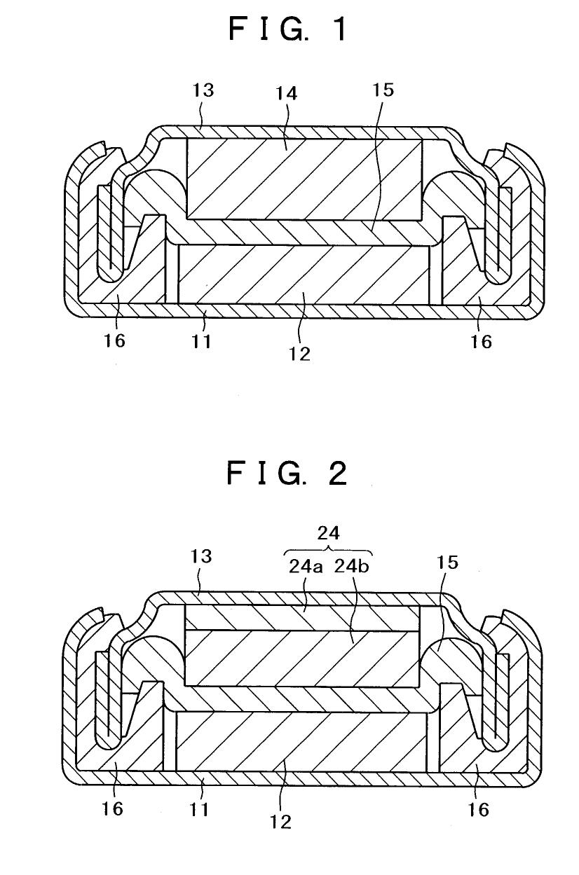

FIG. 1 shows the sectional structure of a secondary battery which employs the negative electrode material according to the first embodiment. The secondary battery is of a so-called coin type in which a negative electrode 14 in a disk shape housed in an outer cup 13 is stacked on a positive electrode 12 in a disk shape housed in an outer can 11 through a separator 15. The outer can 11 and the outer cup 13 are hermetically sealed at their peripheral portions by crimping them through an insulating gasket 16.

Each of the outer can 11 and the outer cup 13 is made of metal such as stainless or aluminum (Al), for example. The outer can 11 serves as a charge collector of the positive electrode 12, while the outer cup 13 serves as a charge collector of the negative electrode 14.

The positive electrode 12 includes, for example, a positive electrode material, and as required, a conductive agent such as carbon black or graphite and a binder such as polyvinylidene fluoride. The positive electrode 12 needs to include, for example, lithium corresponding to a charge/discharge capacity of 250 mAh or higher per gram of the negative electrode material in a steady state (for example, after five cycles of charge/discharge), preferably lithium corresponding to a charge/discharge capacity of 300 mAh or hither, and more preferably lithium corresponding to a charge/discharge capacity of 350 mAh or more. Thus, the positive electrode material preferably includes a sufficient amount of lithium. Examples of the positive electrode material preferably used include a lithium composite metal oxide expressed by the general formula LiₓMlO₂ (Ml represents at least one selected from the group consisting of cobalt (Co), nickel (Ni), and manganese (Mn), and x is defined as O<x<1), or Li_{y}Mll₂O₄ (Mll represents at least one selected from the group consisting of cobalt, nickel, and manganese, and x is defined as 0<y<1), or an intercalation compound including lithium.

It should be noted, however, that all lithium is not necessarily provided by the positive electrode material, and it is essential only that lithium corresponding to a charge/discharge capacity of 250 mAh per gram or higher of the negative electrode material exist in the battery system. The amount of lithium may be determined by measuring the discharge capacity of the battery.

The aforementioned lithium composite metal oxide is prepared by mixing a carbonate, a nitrate, an oxide, or a hydroxide of lithium and a carbonate, a nitrate, an oxide, or a hydroxide of cobalt, manganese, nickel or the like to provide desired composition, crushing it, and then burning it at a temperature from 600 to 1000 ° C. in an oxygen ambient atmosphere.

The negative electrode 14 includes, for example, a porous body in a flat plate form composed of a pure substance, an alloy, or a compound of a metallic element or a semimetallic element that can be alloyed with lithium. In other words, the negative electrode 14 is formed to include the negative electrode material according to the first embodiment. This enables the secondary battery to provide a large discharge capacity and favorable charge/discharge cycle characteristics.

The negative electrode 14 may be formed to include a porous body in powdery form composed of a pure substance, an alloy, or a compound of a metallic element or a semimetallic element that can be alloyed with lithium. In this case, the negative electrode 14 may further include metal powder with electron conductivity or a conductive polymer and a binder such as polyvinylidene fluoride as required.

The separator 15 is provided for isolating the positive electrode 12 from the negative electrode 14 to prevent current short-circuit due to contact between both electrodes while it allows lithium ions to be passed therethrough. The separator 15 is composed of, for example, a porous film formed of a synthetic resin made of polytetrafluoroethylene, polypropylene or polyethylene, or a porous film formed of an inorganic material such as a nonwoven fabric made of ceramic, or may be formed of a stack of two or more kinds of such porous films.

The separator 15 is impregnated with an electrolytic solution which is a liquid electrolyte. The electrolytic solution includes, for example, a solvent and lithium salt which is electrolytic salt. The solvent is provided for dissolving and dissociating the electrolytic salt. Examples of the solvent may include propylene carbonate, ethylene carbonate, diethyl carbonate, methyl ethyl carbonate, 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether, sulfolane, methylsulfolane, acetonitrile, propylnitrile, anisole, acetic acid ester, or propionic acid ester. One or two or more of them may be mixed for use.

Examples of the lithium salt include, for example, LiCO₄, LiAsF₆, LiPF₆, LiBF₄, LiB (C₆H₅)₄, LiCH₃SO₃, LiCF₃SO₃, LiCl, or LiBr. One or two or more of them may be mixed for use.

The secondary battery may be manufactured as described below, for example.

First, for example, a positive electrode mixture is prepared by mixing the positive electrode material, the conductive agent, and the binder, and the positive electrode mixture is compression molded into a disk shape, thereby fabricating the positive electrode 12.

Next, for example, when the porous body in a flat plate form is intended, the porous body is stamped into a disk shape to form the negative electrode 14. In this event, the porous body may be used as it is, or may be compressed for the purpose of preparing the holes. When the porous body in a powdery form is intended, the powder is mixed with the conductive agent and the binder as required to prepare a negative electrode mixture, and then the negative electrode mixture is compression molded into a disk shape, thereby fabricating the negative electrode 14.

After the positive electrode 12 and the negative electrode 14 are formed, the negative electrode 14, the separator 15 impregnated with the electrolytic solution, and the positive electrode 12 are stacked, put into the outer cup 13 and the outer can 11, and crimped. In this manner, the secondary battery shown-in FIG. 1 is completed.

The secondary battery works as follows.

When the secondary battery is charged, lithium ions are desorbed from the positive electrode 12 and absorbed by the positive electrode 12 through the electrolytic solution. When the secondary battery is discharged, for example, lithium ions are desorbed from the negative electrode 14 and absorbed by the positive electrode 12 through the electrolytic solution. Since the negative electrode 14 includes, as the negative electrode material, the porous body composed of the pure substance, the alloy, or the compound of the metallic element or the semimetallic element which can be alloyed with lithium, the excellent ability to absorb and desorb lithium provided by the pure substance, the alloy, or the compound of the metallic element or the semimetallic element which can be alloyed with lithium can achieve a large capacity, and the porous body can provide more satisfactory charge/discharge cycle characteristics.

In this manner, according to the first embodiment, the negative electrode material includes the porous body composed of the pure substance, the alloy, or the compound of the metallic element or the semimetallic element which can be alloyed with lithium, so that a large capacity may be achieved by the excellent ability to absorb and desorb lithium provided by the pure substance, the alloy, or the compound of the metallic element or the semimetallic element which can be alloyed with lithium. In addition, since the volume changes during the absorbing and desorbing lithium may be absorbed in the porous body, it is possible to prevent a breakdown when the secondary battery is repeatedly used.

Especially, the hole rate in the porous body at 5% or higher and 70% or lower, more preferably at 20% or higher and 50% or lower may result in higher effects.

In addition, the secondary battery employing the negative electrode material according to the first embodiment, a large capacity and favorable charge/discharge cycle characteristics may be achieved.

Second Embodiment

FIG. 2 shows the sectional structure of a secondary battery according to a second embodiment of the present invention. The secondary battery has the same configuration as the first embodiment except for the structure of a negative electrode 24. Thus, components identical to those in the first embodiment are designated with the same reference numerals, and detailed descriptions of the same components are omitted.

The negative electrode 24 is formed of a first layer 24a stacked on a second layer 24b. While FIG. 2 shows the first layer 24a disposed closer to an outer cup 13, the second layer 24b may be disposed closer to the outer cup 13 instead. The first layer 24a is composed of a porous body in a flat plate form as described in the first embodiment.

The second layer 24b is formed to include a carbonaceous material capable of absorbing and desorbing lithium which is a negative electrode material, and as required, a binder such as polyvinylidene fluoride. The carbonaceous material is included in this manner because it exhibits an extremely small change in crystal structure at the time of charge and discharge to provide excellent charge/discharge cycle characteristics. Examples of the carbonaceous material include, for example, non-graphitizable carbon, graphitizable carbon, or graphite.

The second layer 24b may also include another negative electrode material in addition to the carbonaceous material which can absorb and desorb lithium. Examples of another negative electrode material include, for example, a metaloxide such as tin oxide (SnO₂), or a polymer material such as polyacethylene and polypyrrole.

The secondary battery can be manufactured similarly to the first embodiment, except that the negative electrode 24 is formed by mixing the carbonaceous material, the binder, and a solvent such as dimethylformamide or N-methly-2-pyrolidone to prepare a negative electrode mixture, applying the negative electrode mixture onto the first layer 24a composed of the porous body to form the second layer 24b, and stamping it out into a disk shape.

In this manner, according to the second embodiment, the negative electrode 24 employs the carbonaceous material which can absorb and desorb lithium as well as the porous body composed of a pure substance, an alloy, or a compound of a metallic element or a semimetallic element which can be alloyed with lithium, thereby achieving more satisfactory charge/discharge cycle characteristics.

While the second embodiment has been described for the use of the porous body in the flat plate form, the porous body in a powdery form may be used. In this case, the first layer 24a may be formed similarly to the negative electrode 14 composed of the powdery porous body described in the first embodiment, and the second layer 24b may include a porous body. When the second layer 24b includes a porous body, the first layer 24a may be removed.

### EXAMPLES

Next, specific examples of the present invention will be described in detail.

### Examples 1 to 6

First, urethane foam was processed to serve as a catalyst and introduced into a solution of electroless copper (Cu) plating. Next, a plating layer of copper was formed on the surface of the urethane foam by immersing the urethane foam in the plating solution while the solution was stirred. Subsequently, the urethane foam having the copper plating layer formed thereon was subjected to electroplating to coat it with plating layer including a layer of copper with a thickness of 5 μm and a layer of tin with a thickness of 5 μm stacked one on another. Then, it was dried and heated. In this manner, an alloy of CuSn was produced and the urethane foam was removed at the same time to form a porous body in a flat plate form. In this event, the thickness of the plating layer was set to be 20 μm in Example 1, 30 μm in Example 2, and 40 μm in Example 3. In each of Examples 4 to 6, the porous body in Example 3 was rolled to form a porous body in a flat plate form. The porous bodies in Examples 1 to 6 thus formed were measured with a mercury porosimeter to determine their hole rates, and the results shown in Table 1 were obtained.

TABLE 1

| | | initial | discharge |
|---|---|---|---|
| | | discharge | capacity |
| | hole rate | capacity | retention |
| | (%) | (mAh/g) | ratio (%) |
| Example 1 | 83 | 515 | 86 |
| Example 2 | 71 | 515 | 92 |
| Example 3 | 53 | 520 | 97 |
| Example 4 | 19 | 510 | 97 |
| Example 5 | 12 | 510 | 95 |
| Example 6 | 4 | 515 | 90 |
| Comparative | 0 | 520 | 73 |
| Example 1 | | | |

In addition, the porous bodies in Examples 1 to 6 were used as the negative electrode material to form test cells of the coin type as shown in FIG. 1.

A lithium metal was used as the positive electrode 12. The negative electrode 14 was formed by stamping the formed porous body into a disk shape with a diameter of 15.5 mm. A porous film made of polypropylene was used as the separator 15. The electrolytic solution used was prepared by dissolving LiPF₆ as lithium salt at a concentration of 1 mol/dm³ in a solvent of ethylene carbonate and dimethyl carbonate mixed at equal volumes. The battery had a size of a diameter of 20 mm and a thickness of 2.5 mm.

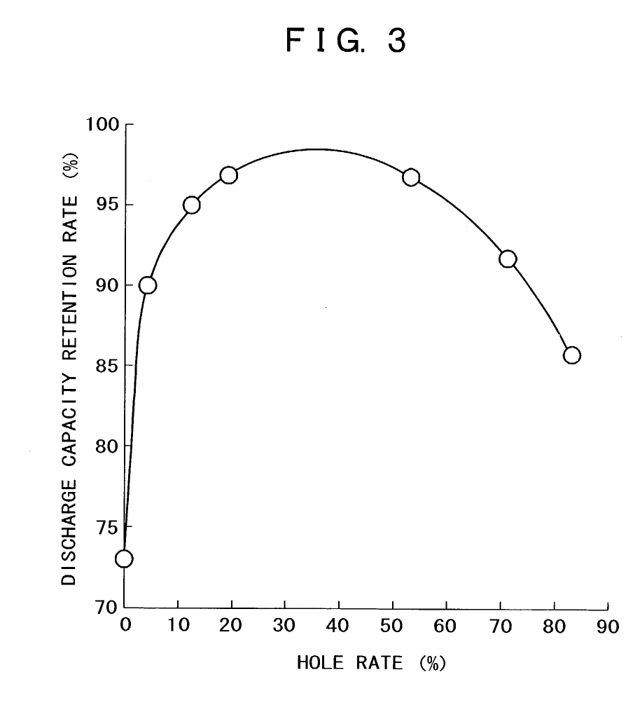

The formed test cells were subjected to a charge/discharge test to examine an initial discharge capacity and a discharge capacity retention rate. In that test, the battery is charged until the cell voltage reaches 0 V at a constant current of 1 mA and then the current value reaches 20 μA at a constant voltage of 0 V. On the other hand, the battery is discharged until the cell voltage reaches 1.2 V at a constant current of 1 mA. It should be noted that the process of the cell voltage drop is referred to as the charge, while the process of the cell voltage rise is referred to as the discharge. The initial discharge capacity was defined as the discharge capacity in the first cycle, and the discharge capacity retention rate was calculated as the percentage representing the ratio of the discharge capacity in the 50th cycle to the discharge capacity in the first cycle. The obtained results are shown in Table 1. FIG. 3 shows the relationship between the discharge capacity retention rate and the hole rate.

As Comparative Example 1 for Examples, a CuSn alloy foil sheet was made in the same manner as Example 1 except that copper foil was used instead of the urethane foam. The CuSn alloy foil sheet in Comparative Example 1 was measured to determine the hole rate similarly to Example 1, which showed that no holes existed. The obtained results are also shown in Table 1.

In addition, the CuSn alloy foil sheet in Comparative Example 1 was used to make a test cell similarly to Example 1, and a charge/discharge test was conducted similarly to examine the initial discharge capacity and the discharge capacity retention rate. The obtained results are also shown in Table 1 and FIG. 3.

As can be seen from Table 1, according to Examples using the porous bodies composed of the CuSn alloy as the negative electrode material, both of the initial discharge capacity and the discharge capacity retention rate exhibited high values of 510 mAh/g or higher and 86% or higher, respectively. In contrast, in Comparative Example 1 using the CuSn alloy foil sheet with no holes, the discharge capacity achieved a high value of 520 mAh/g, while the discharge capacity retention rate exhibited a low value of 73%.

In addition, as can be seen from FIG. 3, the discharge capacity retention rate becomes higher, shows the maximum value, and then is reduced, as the hole rate increases. Especially when the hole rate is 5% or higher and 70% or lower, the discharge capacity retention rate exhibits 90% or higher, and when the hole rate is 20% or higher and 50% or lower, the discharge capacity retention rate exhibits a high value of 97% or higher.

Thus, the use of the porous body made of the alloy which can be alloyed with lithium as the negative electrode material in the negative electrode 14 can achieve a large capacity and excellent charge/discharge cycle characteristics. To provide more excellent charge/discharge cycle characteristics, the hole rate is 5% or higher and 70% or lower, and more preferably, 20% or higher and 50% or lower.

### Example 7

A test cell of the coin type as shown in FIG. 2 was made. In this event, first, petroleum pitch was used as a starting material. A functional group including oxygen is introduced 10% to 20% into the petroleum pitch to provide oxygen bridging, and then burning was performed at 1000 ° C. in an inert gas flow to provide non-graphitizable carbon which is a carbonaceous material with properties close to that of glassy carbon. The non-graphitizable carbon thus provided was measured by X-ray diffraction to reveal a spacing at (002) surface of 0.376 nm and a true density of 1.58 g/cm³. Next, the non-graphitizable carbon was crushed into powder with an average particle diameter of 10 μm. 90 parts by mass of the non-graphitizable carbon was mixed with 10 parts by mass of polyvinylidene fluoride serving as a binder to prepare a negative electrode mixture. Then, the negative electrode mixture was dispersed in dimethylformamide serving as a solvent to provide slurry of the negative electrode mixture. Then, the porous body in Example 3 was prepared as the first layer 24b. The negative electrode mixture slurry was applied to the porous body and dried to complete the second layer 24b. Thereafter, the second layer 24b was stamped into a disk shape with a diameter of 15.5 mm to form the negative electrode 24. The other components were the same as Example 3.

As Comparative Example 2 for Example 7, a test cell was formed similarly to Example 7 except that the CuSn alloy foil sheet in Comparative Example 1 was used for the first layer 24a instead of the porous body in Example 3.

The test cells in Example 7 and Comparative Example 2 were subjected to a charge/discharge test similarly to Example 3 to determine the initial discharge capacity and the discharge capacity retention rate. The obtained results are shown in Table 2 together with the results of Example 3 and Comparative Example 1.

TABLE 2

| | | | initial | discharge |
|---|---|---|---|---|
| | negative | hole | discharge | capacity |
| | electrode | rate | capacity | retention |
| | material | (%) | (mAh/g) | ratio (%) |
| Example 3 | CuSn | 53 | 520 | 97 |
| Example 7 | CuSn + | 53 | 420 | 99 |
| | non-graphitizable | | | |
| | carbon | | | |
| Comparative | CUSn | 0 | 520 | 73 |
| Example 1 | | | | |
| Comparative | CuSn + | 0 | 415 | 75 |
| Example 2 | non-graphitizable | | | |
| | carbon | | | |

As can be seen from Table 2, Example 7 using the porous body composed of the CuSn alloy as the negative electrode material can achieve higher values of both the initial discharge capacity and the discharge capacity retention rate than those in Comparative Example 2 using the CuSn allow foil sheet with no holes. In addition, Example 7 using the non-graphitizable carbon in addition to the porous body composed of the CuSn alloy as the negative electrode material can provide a higher discharge capacity retention rate than Example 3 using only the porous body composed of the CuSn alloy. In other words, it can be seen that more favorable discharge cycle characteristics can be provided when the carbonaceous material is used as the negative electrode material in addition to the porous body composed of the alloy which can be alloyed with lithium.

While the present invention has been described with reference to the embodiments and Examples, the present invention is not limited to the aforementioned embodiments and Examples, and can be modified in various manners. For example, the aforementioned embodiments have been described for the use of the electrolytic solution which is a liquid electrolyte for a solvent, another electrolyte may be used instead of the electrolytic solution. Examples of such an electrolyte include a gel electrolyte holding an electrolytic solution in a polymer, a solid-state electrolyte having ion conductivity, a mixture of a solid-state electrolyte and an electrolytic solution, or a mixture of a solid-state electrolyte and a gel electrolyte.

Various polymers which absorb and gelate electrolytic solution may be used as the gel electrolyte. Such polymers include, for example, fluorine-based polymers such as a copolymer of polyvinylidene fluoride or vinylidene fluoride and hexafluoropropylene, and ether-based polymers such as polyethylene oxide or a cross-linked unit including polyethylene oxide, or polyacrylonitrile. Especially, fluorine-based polymers are preferable in terms of stability of oxidation-reduction.

Examples of the solid-state electrolyte which can be used may include, for example, a polymer composite containing electrolyte salt dispersed in a polymer having ion conductivity, or an inorganic solid-state electrolyte made of ion conductive glass or ionic crystal. Examples of the polymer which can be used may include, for example, a polymer having an ether linkage typified by polyethylene oxide. Examples of the inorganic solid-state electrolyte which can be used may include lithium nitride or lithiumiodide.

While the aforementioned embodiments have been described for the coin-type secondary battery as a specific example, the present invention is applicable similarly to a secondary battery in a cone shape, a button shape, a square shape, or another shape using an outer member such as a laminate film, or a secondary battery having another structure such as a winding structure. In addition, while the aforementioned embodiments have been described for the secondary battery, the present invention is applicable to another battery such as a primary battery.

While the present invention has been particularly shown and described with reference to preferred embodiments according to the present invention, it will be understood by those skilled in the art that any combinations or sub-combinations of the embodiments and/or other changes in form and details can be made therein without departing from the scope of the invention.

What is claimed is:

1. A negative electrode material comprising a porous body comprising a pure substance, an alloy, or a compound of a metallic element or a semimetallic element that can be alloyed with lithium, said porous body having holes in a continuous solid body.

2. The negative electrode material according to claim 1, wherein said porous body has a hole rate ranging from 5% or higher to 70% or lower.

3. The negative electrode material according to claim 2, wherein said porous body has a hole rate ranging from 20% or higher to 50% or lower.

4. The negative electrode material according to claim 1, wherein said porous body comprises an element in Group 4B, or an alloy or a compound of such an element.

5. The negative electrode material according to claim 1, further comprising a carbonaceous material capable of absorbing and desorbing lithium.

6. The negative electrode material according to claim 5, wherein said carbonaceous material is at least one selected from the group consisting of non-graphitizable carbon, graphitizable carbon, and graphite.

7. A battery comprising:
a positive electrode;
a negative electrode; and
an electrolyte,
wherein said negative electrode includes a porous body comprising a pure substance, an alloy, or a compound of a metallic element or a semimetallic element which can be alloyed with lithium, said porous body having holes in a continuous solid body.

8. The battery according to claim 7, wherein said porous body has a hole rate ranging from 5% or higher to 70% or lower.

9. The battery according to claim 8, wherein said porous body has a hole rate ranging from 20% or higher to 50% or lower.

10. The battery according to claim 7, wherein said porous body comprises an element in Group 4B, or an alloy or a compound of such an element.

11. The battery according to claim 7, further comprising a carbonaceous material capable of absorbing and desorbing lithium.

12. The battery according to claim 11, wherein said carbonaceous material is at least one selected from the group consisting of non-graphitizable carbon, graphitizable carbon, and graphite.
